(19) United States
(12) Patent Application Publication
(10) Pub. No.: US 2018/0216365 A1
(43) Pub. Date: Aug. 2, 2018

(54) ACTUATING UNIT HAVING A SECURING ELEMENT AND A ESCUTCHEON ELEMENT

(71) Applicant: EMKA Beschlagteile GmbH & Co. KG, Velbert (DE)

(72) Inventors: Turgay Alan, Remscheid (DE); Joerg Skopnik, Hattingen (DE)

(21) Appl. No.: 15/879,025

(22) Filed: Jan. 24, 2018

(30) Foreign Application Priority Data
Jan. 27, 2017 (DE) 20 2017 100 455.4

(51) Int. Cl. E05B 3/06; E05B 15/02

(52) U.S. Cl. CPC E05B 3/06; E05B 15/02

(57) ABSTRACT

An actuating unit (1) for a closure system includes an actuating element (4) positionable on a door front (2) of a door (16); a shaft (5) configured to be passed through the door (16) and connected to the actuating element (4); a escutcheon element (6) for attachment to the shaft (5) over a free end (7) of the shaft (5) until the escutcheon element (6) bears against a door rear (3); and a securing element (8) for attachment to the shaft (5) over the free end (7). The securing element (8) prevents the escutcheon element (6) from moving back towards the free end (7) of the shaft (5). The securing element (8) is fastened to the escutcheon element (6) so that the escutcheon element (6) and the securing element (8) are attachable to the shaft (5) together.

### CROSS-REFERENCE TO RELATED APPLICATIONS

The present application claims the priority date of Jan. 27, 2017, the filing date of the German patent application DE 20 2017 100 455.4.

### BACKGROUND OF THE INVENTION

The present invention relates to an actuating unit for a closure system, having: an actuating means, which can be arranged on a door front; and a shaft, which can be passed through the door and is connected to the actuating means; and a escutcheon element, which can be attached to the shaft over a free end of the shaft until said escutcheon bears against a door rear; and a securing element, which can be attached to the shaft over the free end and with which the escutcheon element can be prevented from moving back towards a free end of the shaft.

In known actuating units, the escutcheon element is pushed onto the shaft first after the shaft is passed through from the door front, so the door leaf is arranged between a housing bearing the actuating means on the door front and the escutcheon element on the door rear. Then a securing element, which fixes the escutcheon element in its position against the door rear, is attached to the shaft to fix the actuating unit in place. Therefore, several assembly steps are required.

### SUMMARY OF THE INVENTION

It is therefore the object of the present invention to overcome the disadvantages of the prior art and in particular provide an actuating unit which can be fixed to a door leaf or similar more easily.

The object is achieved in particular by an actuating unit having the features mentioned above, in which the securing element is fastened or can be fastened to the escutcheon element so that the escutcheon element and the securing element can be attached to the shaft together.

The basic concept of the invention therefore provides for the securing element to be pre-mounted on the escutcheon element in a loss-proof manner so that the securing element and the escutcheon element form a pre-assembled structural unit, which is easier to handle when the actuating unit is fitted on a door or similar. Therefore, it is not necessary to handle two components independently of each other; rather one structural unit consisting of the securing element and the escutcheon element can be used.

The actuating unit preferably also comprises a housing, which can be arranged on the door front, comes to bear with a flange section on the door front and is preferably arranged with a cylindrical projection in a through-hole in the door. The actuating means is mounted rotatably in the housing.

The escutcheon element in particular has at least one hole, the diameter of which is preferably somewhat greater than the diameter of the shaft so that the escutcheon element can be pushed or placed onto the shaft in a straight movement. In the mounted state, the door leaf or similar is therefore clamped, in particular between the flange-like section of the housing and the escutcheon element. To hold the escutcheon element against the door rear and to fix the actuating unit on the door, the securing element has means which are supported on the shaft and thus prevent a backward movement of the escutcheon element and of the securing element. The securing element is preferably likewise designed such that it can be pushed or placed onto the shaft by means of an exclusively straight movement.

It is then provided for the securing element to be pre-mounted on the escutcheon element with suitable means. For example, the securing element can be pre-mounted on the escutcheon element by means of a latching connection.

Preferably, however, the escutcheon element has a receptacle for the securing element, which receptacle is delimited by a top and a bottom, between which the securing element is arranged. A hole is formed in each case in the top and the bottom, through which hole the shaft can be passed; the receptacle also has a lateral opening, through which the securing element can be introduced or is introduced into the receptacle. The securing element can therefore be pushed into the receptacle through the lateral opening, an opening or hole in the securing element aligning with the holes in the escutcheon element in the pre-assembled state. The securing element is securely held in the escutcheon element in a form-fitting manner in the axial direction of the shaft thanks to a design of this type.

The escutcheon element in particular has a collar, which projects in the direction of the actuating means, that is, parallel to the longitudinal extent of the shaft, and engages in a through-hole in the door when in the mounted state. The shaft is centred in this manner.

The securing element is preferably in the form of a clamping ring. In a preferred embodiment, the clamping ring has a central opening for receiving the shaft, a plurality of clamping protrusions being formed, which project in the direction of the opening and from a circumferential edge in the direction of the central opening or into the central opening. The securing element is supported on the shaft with these clamping protrusions attached to the circumferential edge, in particular in exactly one plane. The in particular flat clamping protrusions are deformed from the circumferential edge towards the free end of the shaft, in particular in the mounted state.

The shaft has, in particular, raised and depressed portions which are arranged one behind the other in the longitudinal direction and on which the securing element is supported, as counter stops. These raised and depressed portions can be formed by a thread or by sections of a thread. Alternatively, they can be formed by annular depressed portions arranged one behind the other in the longitudinal direction.

In addition, it can be provided for the securing element to be flat, that is, to extend in two dimensions in particular in a planar manner. The thickness of the flat securing element is therefore at most a fifth, preferably at most a tenth or even a fifteenth of its edge length, its longitudinal extent or its diameter.

Preferably, the shaft has flattened side regions; preferably at least one hole, which receives the shaft, is formed in the escutcheon element in correspondence with the cross-section of the shaft such that the escutcheon element is arranged in a rotationally fixed manner relative to the shaft.

### BRIEF DESCRIPTION OF THE DRAWINGS

The invention and the technical context are explained by way of example using the drawings. In the figures,

FIG. 1: schematically shows a view of a door rear on which an actuating unit is fastened;

FIG. 2: schematically shows a sectional diagram of the actuating unit fastened to the door;

FIG. 3: schematically shows an exploded view of the actuating unit; and

FIG. 4: schematically shows a escutcheon element and a securing element of the actuating unit in a sectional diagram.

### DETAILED DESCRIPTION OF THE PREFERRED EMBODIMENTS

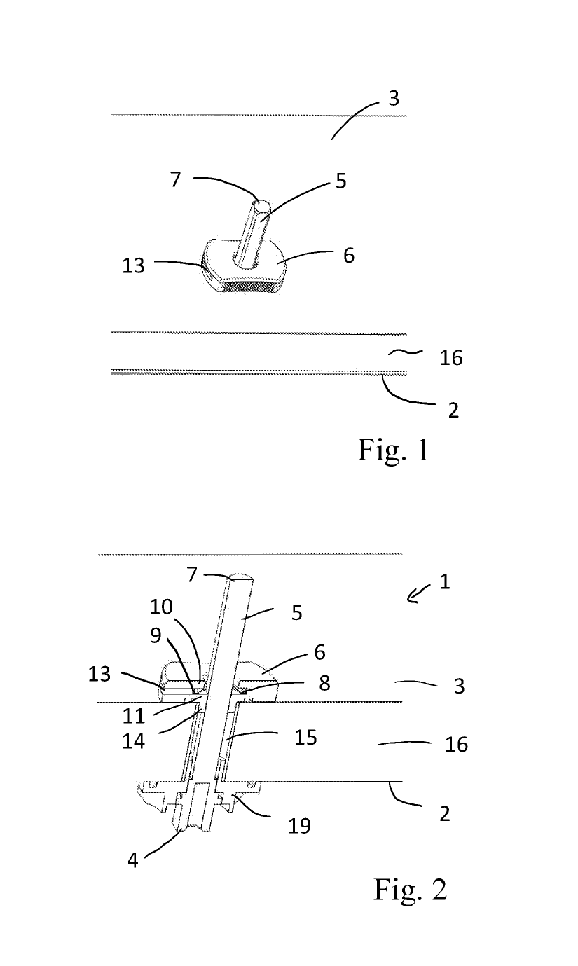

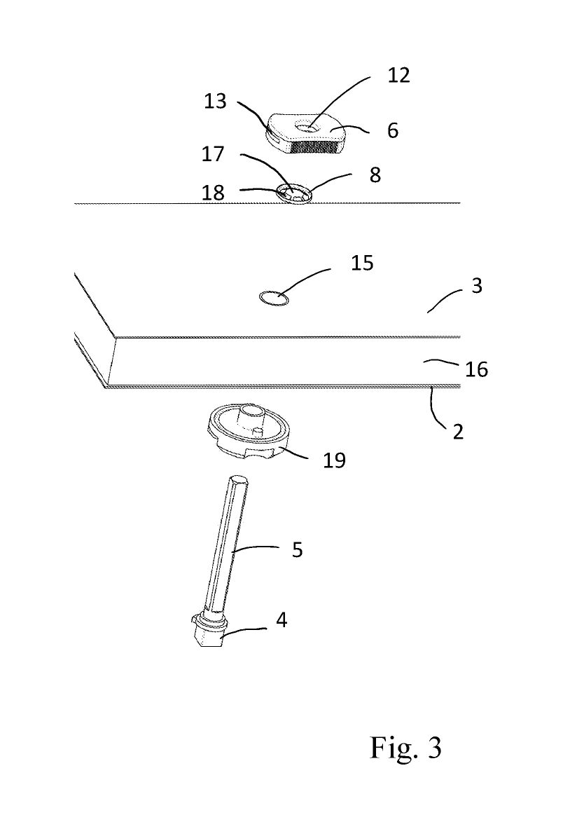

FIGS. 1 to 3 show an actuating unit 1 which is fixed to a door 16. The actuating unit 1 comprises a housing 19, which bears against a door front 2 and engages with a projection into a through-hole 15 in the door 16 (see in particular FIG. 2).

An actuating means 4 is mounted rotatably in the housing 19, the actuating means 4 being formed integrally with a shaft 5. The shaft 5 is passed through the through-hole 15 and projects with a free end 7 from a rear side 3 of the door 16.

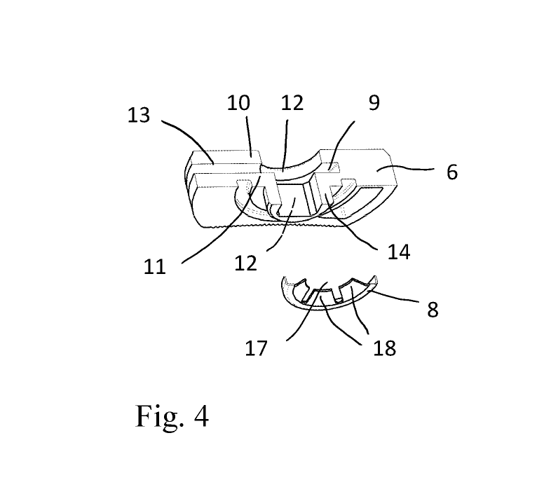

A escutcheon element 6 and a securing element 8 are pushed onto the shaft 5 over the free end 7 of the shaft 5. The escutcheon element 6 and the securing element 8 are shown in detail in FIG. 4. In the escutcheon element 6 is formed a receptacle 9, which is delimited by a top 10 and a bottom 11. A hole 12 is formed in both the top 10 and bottom 11, through which hole the shaft 5 is passed through. The receptacle 9 also has a lateral opening 13, through which the securing element 8 can be pushed into the receptacle 9. A collar 14 is also formed on the escutcheon element 6, which collar engages in the through-hole 15 in the door 16 in the mounted state (see also FIG. 2).

The securing element 8 has a continuously circumferential edge, from which clamping protrusions 18 project in the direction of a central opening 17.

The securing element 8 is pre-mounted in the escutcheon element 6 by being inserted through the lateral opening 13 into the receptacle 9. In the pre-assembled state, the central opening 17 of the securing element 8 is aligned with the holes 12 in the escutcheon element 6.

To mount the actuating device 1, the housing 19 is first placed onto the door front 12, and the shaft 5 is passed through the through-hole 15. Then, the pre-assembled structural unit consisting of the escutcheon element 6 and the securing element 8 is placed onto the shaft 5 over the free end 7, until the door 3 is clamped between the housing 19 and the escutcheon element 6. Since the clamping protrusions 18 are supported on protrusions (not shown) on the shaft 5, the escutcheon element 6 cannot unintentionally come loose towards the free end 7 of the shaft 5. The actuating unit 1 is thus mounted on the door 16 very simply.

Since at least one hole 12 in the escutcheon element 6 has the same cross-sectional shape as the shaft 5, the escutcheon element 6 is connected to the shaft 5 in a rotationally fixed manner.

The specification incorporates by reference the disclosure of DE 20 2017 100 455.4, filed Jan. 27, 2017.

The present invention is, of course, in no way restricted to the specific disclosure of the specification and drawings, but also encompasses any modifications within the scope of the appended claims.

### LIST OF REFERENCE NUMERALS

1 Actuating unit
2 Door front
3 Door rear
4 Actuating means
5 Shaft
6 Escutcheon element
7 Free end
8 Securing element
9 Receptacle
10 Top
11 Bottom
12 Hole
13 Lateral opening
14 Collar
15 Through-hole
16 Door
17 Central opening
18 Clamping protrusion
19 Housing

We claim:

1. An actuating unit (1) for a closure system, comprising:
an actuating means (4) positionable on a door front (2) of a door (16);
a shaft (5) configured to be passed through the door (16) and connected to the actuating means (4);
a escutcheon element (6) for attachment to the shaft (5) over a free end (7) of the shaft (5) until the escutcheon element (6) bears against a door rear (3); and
a securing element (8) for attachment to the shaft (5) over the free end (7), wherein the securing element (8) is configured to prevent the escutcheon element (6) from moving back towards the free end (7) of the shaft (5),
wherein the securing element (8) is fastened to the escutcheon element (6) so that the escutcheon element (6) and the securing element (8) are attachable to the shaft (5) together.

2. The actuating unit (1) according to claim 1, wherein the escutcheon element (6) has a receptacle (9) for the securing element (8), wherein the receptacle (9) is delimited by a top (10) and a bottom (11), wherein the securing element (8) is arranged between the top (10) and the bottom (11), wherein a respective hole (12) is formed in the top (10) and the bottom (11), wherein the shaft (5) passes through each respective hole in the top (10) and the bottom (11), and wherein the receptacle (9) has a lateral opening (13), wherein the securing element (8) is introduced into the receptacle (9) via the lateral opening (13).

3. The actuating unit (1) according to claim 1, wherein the escutcheon element (6) has a collar (14) that projects in a direction of the actuating means (4) and engages in a through-hole (15) in the door (16) in the mounted state.

4. The actuating unit (1) according to claim 1, wherein the securing element (8) is in the form of a clamping ring, wherein the clamping ring has a central opening (17) for receiving the shaft (5) and a plurality of clamping protrusions (18) which project in a direction of the central opening (17).

5. The actuating unit (1) according to claim 1, wherein the shaft (5) has raised and depressed portions arranged one behind the other in a longitudinal direction of the shaft (5), wherein the securing element (8) is supported on the raised and depressed portions.

6. The actuating unit (1) according to claim 1, wherein the securing element (8) is flat or plate-like.

7. The actuating unit (1) according to claim 1, wherein the shaft (5) has flattened side regions.

8. The actuating unit (1) according to claim 7, wherein at least one hole (12) that receives the shaft (5) is formed in the escutcheon element (6) and has the same cross-sectional shape as the shaft (5), such that the escutcheon element (6) is arranged in a rotationally fixed manner relative to the shaft (5).
